(19) United States
(12) Patent Application Publication
(10) Pub. No.: US 2024/0112624 A1
(43) Pub. Date: Apr. 4, 2024

(54) Decoupling Circuit, Driving IC, and Display Device

(71) Applicant: Chengdu Lippxin Microelectronics Co., LTD, Chengdu (CN)

(72) Inventors: Yongsheng Tang, Chengdu (CN); Li Huang, Chengdu (CN); Shilin Shen, Chengdu (CN); Aqiang Liu, Chengdu (CN)

(21) Appl. No.: 18/457,083

(22) Filed: Aug. 28, 2023

(30) Foreign Application Priority Data
Sep. 30, 2022 (CN) 202211208890.6

(51) Int. Cl. G09G 3/32

(52) U.S. Cl. CPC G09G 3/32; G09G 2300/0408; G09G 2320/0257; G09G 2320/0626

(57) ABSTRACT

Provided are decoupling circuit, driving IC, and display device. The decoupling circuit includes pre-charging module and constant current driving module, an output terminal of the pre-charging module and an output terminal of the constant current driving module are connected together to serve as a channel output terminal; within one display unit, when PWM is greater than 0, operation states of the pre-charging module are pre-charging V1, pre-charging off, and pre-charging V2 in sequence, the constant current driving module is turned on based on PWM in stage of the pre-charging off, such that a lamp bead is lit, and at this time, voltage at the channel output terminal is V3; when the PWM is equal to 0, the constant current driving module is turned off, and output states of the pre-charging module are pre-charging V4, pre-charging V5, and pre-charging V6 in sequence, (V1−V3)−(V4−V5)=K1, (V2−V3)−(V6−V5)=K2, K1 and K2 are constants.

### CROSS-REFERENCE TO RELATED APPLICATIONS

The present disclosure claims priority to Chinese patent application No. 202211208890.6, filed with the China Patent Office on Sep. 30, 2022, and entitled “Decoupling Circuit, Driving IC, and Display Device”, the entire content of which is incorporated by reference herein.

### TECHNICAL FIELD

The present disclosure relates to the field of integrated circuits, and specifically to a decoupling circuit, a driving IC, and a display device.

### BACKGROUND ART

An LED (Light Emitting Diode) display screen is generally composed of m rows*n columns of lamp beads, which are subjected to display driving by row driving ICs and column driving ICs. Due to parasitic capacitance on a row line and a column line, a coupling phenomenon is generated in an LED display process. In addition, the parasitic capacitance also causes phenomena such as an upper ghost image and a lower ghost image to appear on the LED display screen. The coupling phenomenon of the LED display screen is mainly affected by various parasitic parameters on the PCB, board-end wiring, lamp bead parameters, etc., and the coupling phenomenon can only be weakened and cannot be completely eliminated. The generation principle thereof is as shown in FIGS. 1, D11 and D12 are two lamp beads in the same row connected in a common anode manner, and are two adjacent LEDs in position on the PCB. There is a relatively small parasitic capacitance Cm between cathodes of D11 and D12, Sr1a is turned on when a first row is scanned, assuming that D11 is set to be turned off at this time, and grayscale is 0, then Sc1a is turned off, and assuming that D12 is set to be turned on at this time and grayscale is relatively large, Sc2a is turned on, and since the cathode of D11 is in an uncontrollable float state at this time, neither is turned on nor is in a state of eliminating the ghost image, when D12 is switched from the state of eliminating the ghost image to an on state, a cathode voltage thereof jumps from a relatively high voltage to a relatively low voltage of the on state, as shown by a waveform on the right side of FIG. 1, due to existence of the capacitance Cm, the signal will be coupled to the cathode of D11, causing a negative transition to the cathode voltage of D11, such that D11 is slightly turned on, as shown by a left waveform. As high grayscale LED is coupled to adjacent LED with low grayscale or zero grayscale, it is also commonly referred to as high-low grayscale coupling. In addition to the phenomenon of high-low grayscale coupling, there is also a cross-board coupling phenomenon. The cross-board coupling phenomenon, means that, there is a vertical line with obvious brightness boundary at boundary of a spliced screen. The essence of generating the cross-board coupling is continuous coupling effect of a post-grayscale to a pre-stage, which continuously raises a clamping voltage of the pre-stage. Such coupling effect becomes slighter when it comes to post-grayscale, and becomes sever for the pre-stage, in this way, a part with lower brightness is less bright, and a clear brightness dividing line will be seen at a position between two row tubes and a physical splicing position of modules.

In order to reduce influences of the parasitic capacitance, a conventional practice is to apply a shadow elimination voltage to the lamp beads through a pre-charging circuit before display, such that the lamp beads have the same clamping voltage before the display through the shadow elimination voltage. Voltage jump generated in this process releases charges of the parasitic capacitance. This manner solves the phenomena of the upper ghost image and the lower ghost image generated by the parasitic capacitance to some extent, but the effect on the coupling phenomenon of the display screen is not ideal.

### SUMMARY

The present disclosure aims at providing a decoupling circuit, a driving IC, and a display device, so as to overcome the shortcomings in the prior art, wherein not only phenomena of upper ghost image and lower ghost image on an LED display screen can be eliminated, but also the coupling phenomenon of the display screen can be greatly reduced.

Objectives of the present disclosure are achieved through the following technical solutions.

In a first aspect, the present disclosure provides a decoupling circuit, including a pre-charging module and a constant current driving module, an output terminal of the pre-charging module and an output terminal of the constant current driving module being connected together to serve as a channel output terminal, wherein
within one display unit, when PWM is greater than 0, operation states of the pre-charging module are pre-charging V1, pre-charging off (turning off of pre-charging), and pre-charging V2 in sequence, the constant current driving module is turned on based on PWM in a stage of the pre-charging off, such that a lamp bead is lit, and at this time, the voltage at the channel output terminal is V3;
within one display unit, when the PWM is equal to 0, the constant current driving module is turned off, and output states of the pre-charging module are pre-charging V4, pre-charging V5, and pre-charging V6 in sequence, wherein
(V1−V3)−(V4−V5)=K1, (V2−V3)−(V6−V5)=K2, K1 and K2 are constants.

In the present disclosure, by adjusting potentials of pre-charging V1, V2, V4, V5, and V6, the decoupling circuit has the same decoupling capability when PWM displayed by the lamp beads is greater than 0 and the PWM is equal to 0, such that the optimal decoupling effect can be achieved, and meanwhile, the lower ghost image phenomenon also can be eliminated through the pre-charging V1, V2, V4, and V6.

Further, when the PWM is greater than 0, duration of the state of the pre-charging off is greater than or equal to the display time of the PWM.

Further, none of the pre-charging V1, the pre-charging V2, the pre-charging V4, the pre-charging V5, and the pre-charging V6 is sufficient to turn on the lamp bead.

Preferably, the (V1−V3) is equal to or about equal to (V4−V5), and (V2−V3) is equal to or about equal to (V6−V5).

Further, in a common anode display screen, V3<V5, and in a common cathode display screen, V3>V5.

Further, in a common cathode display screen, V3>V1, V3>V2, and V5>V4; and in a common anode display screen, V3<V1, V3<V2, and V5<V4.

Optionally, the pre-charging module includes one off state between V1 and V3, between V3 and V2, between V4 and V5, and between V5 and V6, and duration of the off state is t, where t≥0.

Further, the display unit refers to a minimum display packet with grayscale data being in one sub-frame.

In a second aspect, the present disclosure provides another decoupling circuit, including a pre-charging module and a constant current driving module, wherein an output terminal of the pre-charging module and an output terminal of the constant current driving module are connected together as a channel output terminal, wherein
within one display unit, when PWM is greater than 0, operation states of the pre-charging module are pre-charging V1 and pre-charging off in sequence, the constant current driving module is turned on based on PWM in a stage of the pre-charging off, such that a lamp bead is lit, and at this time, a voltage at the channel output terminal is V3;
within one display unit, when the PWM is equal to 0, the constant current driving module is turned off, and output states of the pre-charging module are pre-charging V4, pre-charging V5, and pre-charging off in sequence, wherein
(V1−V3)−(V4−V5)=K1, K1 is a constant.

In a third aspect, the present disclosure provides a driving IC, wherein the driving IC includes the decoupling circuit according to the first aspect or the second aspect.

In a fourth aspect, the present disclosure provides a display device, including a driving IC according to the third aspect and a display panel including an LED display screen.

The beneficial effects of the present disclosure are as follows: compared with conventional decoupling, different from the practice of enabling the lamp beads to the same clamping voltage before display through pre-charging in the prior art, the present disclosure provides different pre-charging potentials according to different parasitic capacitances to be eliminated of different lamp beads, so that when PWM=0 and PWM>0, the same decoupling capability is provided, and charging potentials required for different lamp beads are different, thereby improving the decoupling effect of the display screen as a whole.

### BRIEF DESCRIPTION OF DRAWINGS

FIG. 1 is a principle diagram of generating a coupling phenomenon by parasitic capacitance;

FIG. 2 is a schematic diagram of a circuit structure according to an embodiment of the present disclosure;

FIG. 3 is a schematic diagram of a certain embodiment of the present disclosure where PWM is greater than 0;

FIG. 4 is a schematic diagram of another embodiment of the present disclosure where PWM is greater than 0;

FIG. 5 is a schematic diagram of a certain embodiment of the present disclosure where PWM is equal to 0;

FIG. 6 is a schematic diagram of another embodiment of the present disclosure where PWM is equal to 0;

FIG. 7 is a schematic diagram of a further embodiment of the present disclosure where PWM is greater than 0;

FIG. 8 is a schematic diagram of a further embodiment of the present disclosure where PWM is equal to 0; and

FIG. 9 is a schematic diagram of principle of grayscale data display.

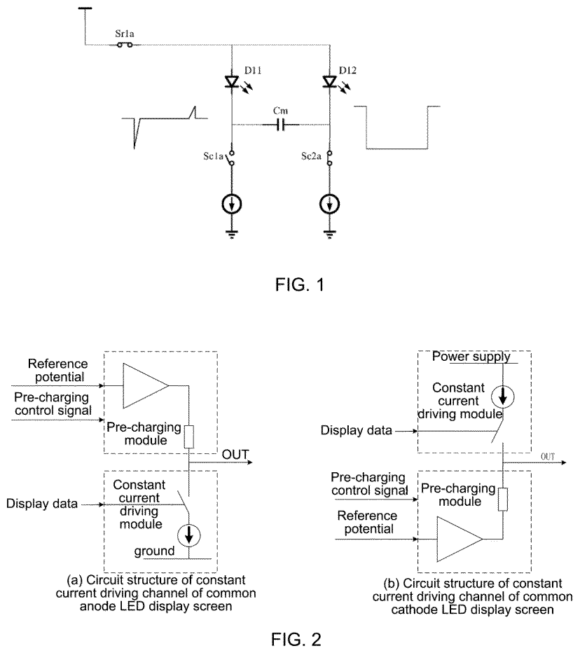

### DETAILED DESCRIPTION OF EMBODIMENTS

The technical solutions of the present disclosure are further described in detail below in combination with specific embodiments, but the scope of protection of the present disclosure is not limited to the following.

In a first aspect, the present embodiment provides a decoupling circuit, including a pre-charging module and a constant current driving module, wherein an output terminal of the pre-charging module and an output terminal of the constant current driving module are connected together to serve as a channel output terminal.

With reference to what is shown in FIG. 2, the output terminal of the pre-charging module and the output terminal of the constant current driving module are connected together, wherein a switch is provided between the constant current driving module and the channel output terminal OUT, the switch is controlled by display data, wherein the display data is a PWM signal of a current display unit, when the PWM is greater than 0, the switch is closed, the constant current driving module outputs a constant current, and the lamp bead is turned on. PWM is a waveform signal representing grayscale data, and PWM being greater than 0 indicates that the represented grayscale data is greater than 0. When the PWM is equal to 0, the switch is always switched off, that is, the constant current driving module and the channel output terminal are in a disconnected state, which is equivalent to that the constant current driving module is turned off. The pre-charging module performs voltage pre-charging output based on a reference voltage and a pre-charging control signal, and the pre-charging control signal is configured to control an output state (on or off) of the pre-charging module and an output voltage value.

In the above, the pre-charging module and the constant current driving module are not simultaneously turned on, when PWM display is performed, the pre-charging module is turned off, the constant current driving module is turned on and outputs a constant current to turn on the lamp bead, and after the PWM display ends, the pre-charging module is turned on and outputs pre-charging voltage, and the constant current driving module is turned off. In other words, the pre-charging module and the constant current driving module are in a mode of outputting alternatively, but the pre-charging module and the constant current driving module can be simultaneously turned off.

It should be noted that, the pre-charging module wiring methods of a common anode LED display screen and a common cathode LED display screen are different and the constant current driving module wiring methods of the common anode LED display screen and the common cathode LED display screen are also different. In the common anode LED display screen shown in FIG. 2(a), the constant current driving module is grounded, and the pre-charging module is connected to a power supply, and in the common cathode LED display screen shown in FIG. 2(b), the constant current driving module is connected to a power supply, and the pre-charging module is grounded.

The pre-charging module outputs based on the pre-charging control signal, wherein the pre-charging control signal can be register-configured or can be manually adjusted. A reference potential is the reference voltage provided to the pre-charging module, and gain adjustment is performed based on the reference voltage, so as to output different pre-charging potentials.

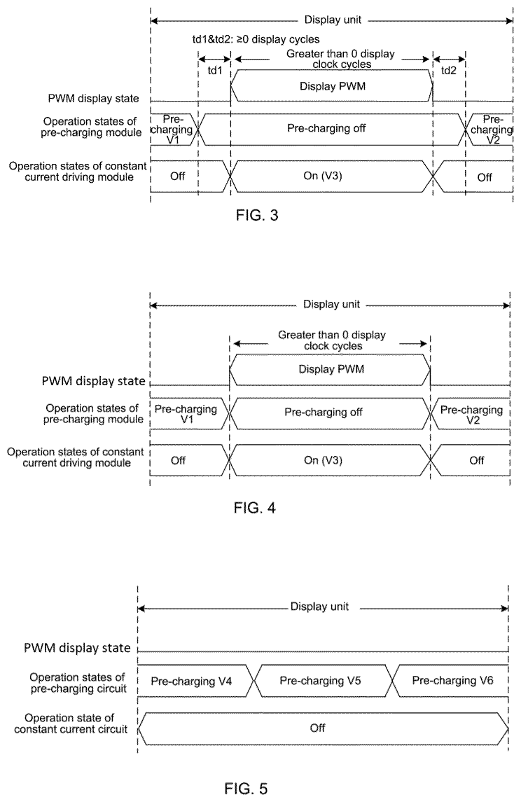

Within one display unit, when the PWM is greater than 0, operation states of the pre-charging module are pre-charging V1, pre-charging off, and pre-charging V2 in sequence. The constant current driving module is turned on based on PWM in a stage of the pre-charging off, such that the lamp bead is lit, and at this time, a voltage at the channel output terminal is V3, wherein duration of a pre-charging off state is longer than or equal to display time of the PWM, so as to ensure normal display of the PWM. That is, the PWM display is completed within a time period corresponding to the pre-charging off, and the display time of the PWM is less than or equal to the duration of the pre-charging off state. On a time axis, output voltages of the channel output terminal are V1, V3, and V2 in sequence, and reference can be made to FIG. 3 for principle thereof.

FIG. 3 shows a sequence diagram of a PWM display state, operation states of the pre-charging module, and operation states of the constant current driving module within one display unit. In the above, the constant current driving module is only turned on during a time period for displaying PWM to turn on the lamp bead, and in the remaining time periods, the constant current driving module is always turned off, and the lamp bead is turned off. That is, the time period for displaying PWM and the time period of turning on the constant current driving module are completely overlapped, as shown in FIG. 3.

The time period for displaying PWM is completely located within the time period of pre-charging off. Exemplarily, the time period for displaying PWM may be aligned with a start point of the time period of pre-charging off, an end point of the time period of pre-charging off, or both the start point and the end point of the time period of pre-charging off (i.e., the time period for displaying PWM is overlapped with the time period of pre-charging off), or, the time period for displaying PWM is neither aligned with the start point nor the end point of the time period of pre-charging off (i.e., the time for displaying PWM is located in the time period of pre-charging off), as shown in FIG. 3.

As shown in FIG. 3, duration of the pre-charging off state is greater than display time of the PWM, the start point of the pre-charging off state is ahead of the start point of displaying PWM by time td1, the end point of the pre-charging off state is delayed by time td2 than the end point of displaying PWM, wherein td1 and td2 are both greater than or equal to 0 display cycles, i.e., duration of the pre-charging off state is greater than or equal to the display time of the PWM.

As shown in FIG. 4, the duration of the pre-charging off state is equal to the display time of the PWM, that is, the pre-charging off state and the display time of the PWM are overlapped and equal, and in this case, td1 and td2 are both equal to 0.

Within one display unit, when the PWM is equal to 0, the constant current driving module is turned off, and output states of the pre-charging module are pre-charging V4, pre-charging V5, and pre-charging V6 in sequence. As PWM is equal to 0, i.e., no grayscale data is displayed, the lamp bead is in an off state in this display unit, the constant current driving module is completely turned off in the display unit, and the pre-charging module just needs to output three states of pre-charging V4, pre-charging V5, and pre-charging V6 in sequence in the display unit.

With reference to what is shown in FIG. 5, within one display unit, as PWM is equal to 0, the PWM display state is empty, i.e., PWM is at a low level, and it can also be understood as that the PWM is in an off state within this display unit, and the corresponding constant current driving module is always in an off state. The output states of the pre-charging module are the pre-charging V4, the pre-charging V5, and the pre-charging V6 in sequence, wherein durations of the pre-charging V4, the pre-charging V5, and the pre-charging V6 do not have a fixed requirement, as long as they are greater than 0. With reference to the embodiment shown in FIG. 5, the three states of pre-charging V4, pre-charging V5, and pre-charging V6 are seamlessly connected to fill up the entire display unit. In the above, the pre-charging V5 is used to simulate a voltage at which the lamp bead is turned on, but is not enough to turn on the lamp bead.

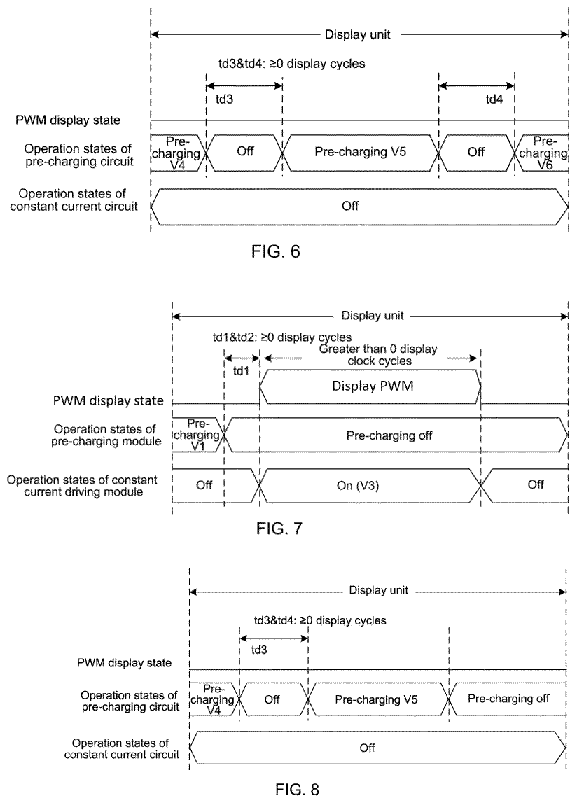

With reference to what is shown in FIG. 6, it shows deformation generated by adjusting durations of the pre-charging V4, the pre-charging V5, and the pre-charging V6, i.e., one off state is inserted between the pre-charging V4 and the pre-charging V5, and one off state is inserted between the pre-charging V5 and the pre-charging V6, such that the pre-charging V4, the pre-charging V5, and the pre-charging V6 appear intermittently rather than continuously, wherein time of the off state is td3 and td4 respectively. By the same reason, it is also feasible that the pre-charging V4 and the pre-charging V5 are continuous, and the pre-charging V5 and the pre-charging V6 are discontinuous, and it is also feasible that the pre-charging V4 and the pre-charging V5 are discontinuous, and the pre-charging V5 and the pre-charging V6 are continuous. It is only required that the three states of pre-charging V4, pre-charging V5, and pre-charging V6 appear in sequence in one display unit, that is, values of td3 and td4 are both greater than or equal to 0.

Still further, in order to improve the decoupling effect, the pre-charging V1, the pre-charging V2, the pre-charging V4, the pre-charging V5, and the pre-charging V6 in the present embodiment should satisfy a constant relationship.

That is to say, (V1−V3)−(V4−V5)=K1, (V2−V3)−(V6−V5)=K2, where K1 and K2 are constants. The constants K1 and K2 herein are not fixed values, and based on different LED display arrays, the values of K1 and K2 vary slightly. In an ideal state, (V1−V3)=(V4−V5), (V2−V3)=(V6−V5), i.e., the constant K1=K2=0. In practical applications, test may also be performed according to a specific LED display screen, so as to determine values of the constants, and generally, the values of K1 and K2 fluctuate around 0, i.e., (V1−V3) is equal to or about equal to (V4−V5), and (V2−V3) is equal to or about equal to (V6−V5). In order to simplify a test process, 0 can be directly taken, and compared with the prior art, the decoupling effect thereof is also significantly improved.

It should be noted that the pre-charging module is configured to eliminate influences of the parasitic capacitance, and will not turn on the lamp beads, therefore, none of the pre-charging V1, the pre-charging V2, the pre-charging V4, the pre-charging V5, and the pre-charging V6 is sufficient to turn on the lamp beads.

The pre-charging functions to reduce influences of the parasitic capacitance on the display coupling, therefore, the pre-charging voltage cannot turn on the lamp beads. Instead, a voltage jump process is provided, and charges generated due to the parasitic capacitance are released by means of this jump voltage. Based on formula Q=C*V (in which * denotes product sign), where Q represents charge amount, C represents capacitance, V represents voltage, for a certain lamp bead, the parasitic capacitance C thereof is fixed. Therefore, magnitude of charges released by the parasitic capacitance depends on the value of the voltage. A voltage jump is required to make the parasitic capacitance release the charges. Therefore, the pre-charging V1, pre-charging V2, pre-charging V4, pre-charging V5, and pre-charging V6 are to produce this voltage jump, for releasing the charges generated by the parasitic capacitance, and when adjacent lamp beads of this lamp bead are turned on, this lamp bead will not be slightly conducted due to the parasitic capacitance, thus, the coupling phenomenon is reduced.

Based on driving characteristics of the common anode display screen and the common cathode display screen, V3<V5 in the common anode display screen, and V3>V5 in the common cathode display screen. Further, in the common cathode display screen, V3>V1, V3>V2, and V5>V4; and in the common anode display screen, V3<V1, V3<V2, and V5<V4.

Generally, in the anode (common anode) display screen, each voltage may be configured as follows:
V1≈3.5V, V3≈1V, V2≈:3.5V, V4≈5V, V5≈3V, and V6≈3.5V.

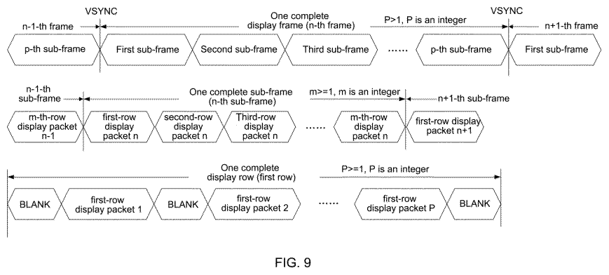

Further, the display unit in the present disclosure refers to a minimum display packet with grayscale data being in one sub-frame, and may be understood as one minimum packet of PWM display. With reference to what is shown in FIG. 9, it is a schematic diagram of display of row scanning driving chip, and it can be seen based on common knowledge that a display image is composed of a plurality of continuous frames of images. The driving IC refreshes the frame according to frame refresh instruction VSYNC, and in order to improve refresh rate of display, one frame of image is divided into several sub-frames to display.

With reference to what is shown in a first row of FIG. 9, a complete display frame includes P sub-frames, where P is an integer. Each sub-frame further includes m groups of display packet data, where m is the number of rows of the display screen, that is, a complete sub-frame includes one piece of display packet data of all rows of the display screen. The display data of each row is further divided into P groups, i.e., all the greyscale data of the display row are scattered into all the sub-frames of the display frame, and the display unit in the present disclosure is a display cycle, in which the display cycle refers to the time needed for displaying one display packet. Taking 13-bit grayscale data as an example for description, assuming that an LED display screen includes 16 rows*16 columns, and grayscale data is divided into 32 groups of display packets, then one complete display frame includes 32 sub-frames, and each sub-frame includes 16 groups of display packet data (one piece of display packet data per row), that is, one sub-frame includes 16 display units. Each display packet includes 7-bit grayscale data, and the grayscale data value of each display packet is 0-256, that is, the PWM of this display packet is 0-256, when the PWM is 0, it indicates that the grayscale data of this display packet is 0, that is, the time for the display unit to display the PWM is 0-256 display clock cycles, where the display clock cycle herein is a clock inherent to a system, and is unit time of the PWM.

In a second aspect, the present embodiment provides another decoupling circuit, including a pre-charging module and a constant current driving module, wherein an output terminal of the pre-charging module and an output terminal of the constant current driving module are connected together as a channel output terminal. Different from the preceding embodiment, one pre-charging state is reduced in both cases where the PWM is greater than 0 and the PWM is equal to 0 in the present embodiment.

With reference to what is shown in FIG. 7, within one display unit, when the PWM is greater than 0, operation states of the pre-charging module are pre-charging V1 and pre-charging off in sequence, and the constant current driving module is turned on based on PWM in a stage of the pre-charging off, such that the lamp bead is lit, and at this time, a voltage at the channel output terminal is V3.

With reference to what is shown in FIG. 8, within one display unit, when the PWM is equal to 0, the constant current driving module is turned off, and output states of the pre-charging module are pre-charging V4, pre-charging V5, and pre-charging off in sequence.

In a third aspect, the present embodiment provides a driving IC, wherein the driving IC includes the decoupling circuit according to the preceding embodiments, and the driving IC has a good decoupling effect.

In a fourth aspect, the present disclosure provides a display device, including the driving IC and a display panel, wherein the driving IC and the display panel perform display, and the display panel includes an LED display screen.

The above-mentioned are merely preferred embodiments of the present disclosure, and it should be understood that the present disclosure is not restricted to the forms disclosed herein, other embodiments should not be regarded as being excluded, but may be used in various other combinations, modifications, and environments, and can be altered through the above teachings or technologies or knowledge in related art within a scope of concept described herein. However, alterations and changes made by those skilled in the art do not depart from the spirit and scope of the present disclosure, and should all fall within the scope of protection of the appended claims of the present disclosure.

1. A decoupling circuit, comprising a pre-charging module and a constant current driving module, an output terminal of the pre-charging module and an output terminal of the constant current driving module being connected together to serve as a channel output terminal, wherein
within one display unit, when PWM is greater than 0, operation states of the pre-charging module are pre-charging V1, pre-charging off, and pre-charging V2 in sequence, the constant current driving module is turned on based on PWM in a stage of the pre-charging off, such that a lamp bead is lit, and at this time, the voltage at the channel output terminal is V3; and
within one display unit, when the PWM is equal to 0, the constant current driving module is turned off, and output states of the pre-charging module are pre-charging V4, pre-charging V5, and pre-charging V6 in sequence, wherein
(V1−V3)−(V4−V5)=K1, (V2−V3)−(V6−V5)=K2, K1 and K2 are constants.

2. The decoupling circuit according to claim 1, wherein when the PWM is greater than 0, a duration of a state of the pre-charging off is greater than or equal to a display time of the PWM.

3. The decoupling circuit according to claim 1, wherein none of the pre-charging V1, the pre-charging V2, the pre-charging V4, the pre-charging V5, and the pre-charging V6 is sufficient to turn on the lamp bead.

4. The decoupling circuit according to claim 1, wherein in a common anode display screen, V3<V5, and in a common cathode display screen, V3>V5.

5. The decoupling circuit according to claim 1, wherein in a common cathode display screen, V3>V1, V3>V2, and V5>V4; and
in a common anode display screen, V3<V1, V3<V2, and V5<V4.

6. The decoupling circuit according to claim 1, wherein the pre-charging module comprises one off state between V1 and V3, between V3 and V2, between V4 and V5, and between V5 and V6, and a duration of the off state is t, where t≥0.

7. The decoupling circuit according to claim 1, wherein the display unit refers to a minimum display packet with grayscale data being in one sub-frame.

8. A decoupling circuit, comprising a pre-charging module and a constant current driving module, wherein an output terminal of the pre-charging module and an output terminal of the constant current driving module are connected together as a channel output terminal, wherein
within one display unit, when PWM is greater than 0, operation states of the pre-charging module are pre-charging V1 and pre-charging off in sequence, the constant current driving module is turned on based on PWM in a stage of the pre-charging off, such that the lamp bead is lit, and at this time, the voltage at the channel output terminal is V3; and
within one display unit, when the PWM is equal to 0, the constant current driving module is turned off, and output states of the pre-charging module are pre-charging V4, pre-charging V5, and pre-charging off in sequence, wherein
(V1−V3)−(V4−V5)=K1, K1 is a constant.

9. A driving IC, wherein the driving IC comprises the decoupling circuit according to claim 1.

10. (canceled)

11. The driving IC according to claim 9, wherein when the PWM is greater than 0, a duration of a state of the pre-charging off is greater than or equal to a display time of the PWM.

12. The driving IC according to claim 9, wherein none of the pre-charging V1, the pre-charging V2, the pre-charging V4, the pre-charging V5, and the pre-charging V6 is sufficient to turn on the lamp bead.

13. The driving IC according to claim 9, wherein in a common anode display screen, V3<V5, and in a common cathode display screen, V3>V5.

14. The driving IC according to claim 9, wherein in a common cathode display screen, V3>V1, V3>V2, and V5>V4; and
in a common anode display screen, V3<V1, V3<V2, and V5<V4.

15. The driving IC according to claim 9, wherein the pre-charging module comprises one off state between V1 and V3, between V3 and V2, between V4 and V5, and between V5 and V6, and a duration of the off state is t, where t≥0.

16. The driving IC according to claim 9, wherein the display unit refers to a minimum display packet with grayscale data being in one sub-frame.
